(19) United States
(12) Patent Application Publication
(10) Pub. No.: US 2003/0037191 A1
(43) Pub. Date: Feb. 20, 2003

(54) Wireless module

(76) Inventors: Robert Baranowski, San Diego, CA (US); Tai-Po Chu, San Diego, CA (US)

Correspondence Address: SKJERVEN MORRILL LLP, 25 METRO DRIVE, SUITE 700, SAN JOSE, CA, 95110, US

(21) Appl. No.: 09/928,582

(22) Filed: Aug. 13, 2001

(51) Int. Cl. G06F 13/12

(52) U.S. Cl. 710/62

(57) ABSTRACT

Communication modules and methods of using the communication modules are provided. One communication module comprises an interface circuit and a receiver. The interface circuit is configured to be coupled to a port of a first electronic device. The port is configured to receive data from a memory module. The receiver is coupled to the interface circuit. The receiver is configured to wirelessly receive at least one signal from a second electronic device and send the signal to the interface circuit. The interface circuit is configured to send data associated with at least one signal received by the receiver to the port of the first electronic device.

### BACKGROUND OF THE INVENTION

1. Field of the Invention

The present invention relates to removable data storage devices. More particularly, the present invention relates to a data storage and wireless transmission module.

2. Description of the Related Art

Some memory devices are removable. For example, Memory Stick™ is a removable data storage device made by Sony Corporation. Memory Stick™ is a recordable integrated circuit (IC) digital storage media that has greater storage capacity than a standard 3.5 inch floppy disk, yet has a size smaller than a stick of gum. Similar to a floppy disk, Memory Stick™ data storage media is plugged into a socket at a host device, the host device may be any digital or electronic device. After plugging into a socket at the host device, the Memory Stick™ data storage media allows the users to transfer information such as data, text, graphics or digital images from one electronic device to another. For example, a digital camcorder or a digital camera may store digital images on Memory Stick™ data storage media and then transfer the images onto a laptop or desktop computer.

Compared to other IC storage media, Memory Stick™ data storage media is smaller in size than, for example, compact flash and smart media. Memory Stick™ data storage media is also very lightweight, making it ultra-portable. In addition, the diminutive size and ergonomic design of Memory Stick™ data storage media makes it easier to insert, remove and carry than any other IC storage media. Being portable and easy to use, Memory Stick™ data storage media is ideal for small electronic devices such as cameras, laptop computers and camcorders to enhance their power of sharing, that is, sharing their digital information with anyone of any age, at any time, anywhere in the world.

Currently, communication and storage media functions on an electronic device utilize separate hardware. For example, a laptop computer utilizes one socket for a storage device and another socket for communication. For example, the socket which accepts Memory Stick™ data storage media provides only data storage capabilities. As electronic devices become more portable and as the Memory Stick™ data storage media grows in popularity, more and more portable devices will be compatible with the Memory Stick™ data storage media. However, these devices must include additional hardware, e.g., a separate socket, for communication, which requires valuable space on the device.

### SUMMARY OF THE INVENTION

One aspect of the invention relates to a socket configured to accept a data storage device, such as a Memory Stick™, and/or modules with other functionalities, such as communication.

Although Memory Stick™ data storage media is portable and easy to use, a user must insert the Memory Stick™ data storage media in a first device to store digital information, remove the Memory Stick™ data storage media from the first device, and insert the Memory Stick™ data storage media in a second device, to transfer digital information of the first device stored on the Memory Stick™ data storage media to the second device. This procedure may be repetitive and inconvenient, especially when two digital devices are in close proximity to each other.

Another aspect of the invention relates to a device with a socket that accepts a data storage device, such as a Memory Stick™ data storage media, and/or a module with the capability to create and control a communication link between two electronic devices. In accordance with the present invention, a communication module comprises an interface circuit for communicating data to a data processing apparatus. The interface circuit comprises a synchronizing signal input circuit for acquiring a synchronizing signal from the data processing apparatus, a control signal input circuit for acquiring a control signal from the data processing apparatus, and a data input/output circuit for transmitting and receiving the data. The communication module also comprises a signal processing circuit for processing the data and a controller for controlling the interface circuit and the signal processing circuit.

In one embodiment, the communication module comprises a register for temporarily storing the data prior to supplying the data to the signal processing circuit and prior to supplying the data to the data processing apparatus. Versatility is added to a socket that accepts Memory Stick™ data storage media by allowing a communication module to be compatible with the socket.

In one embodiment, the communication module comprises a memory for data storage. In one embodiment, the memory is a non-volatile memory, for example, a flash memory. By integrating communication capability into a memory storage module, no additional hardware is needed to create and control a communication link between two electronic devices, thereby saving cost.

In one embodiment, the communication module is a wireless module. A wireless module eliminates many hardware requirements and adds mobility to the user.

In one embodiment, the signal processing circuit comprises a transceiver for transmitting and receiving a signal and a baseband processing unit for processing the signal. In one embodiment, the baseband processing unit comprises a packetize/depacketize unit. In one embodiment, the baseband processing unit comprises an error correction unit.

In one embodiment, the communication module is capable of hot-swap.

In one embodiment, a communication system comprises multiple data processing apparatuses. Multiple data processing apparatuses allow communication and memory storage without hot-swapping. In one embodiment, hot-swap capability is provided for the communication system.

### DESCRIPTION OF THE DRAWINGS

The present invention may be better understood, and its numerous objects, features, and advantages made apparent to those skilled in the art by referencing the accompanying drawings.

FIG. 1 is a block diagram of one embodiment of a processing apparatus and a memory module.

FIG. 2 shows one embodiment of an output circuit for the memory module in FIG. 1.

FIG. 3 is a block diagram of one embodiment of a processing apparatus and a communication module.

FIG. 4 is a block diagram of one embodiment of the card side serial interface circuit in FIG. 3.

FIG. 5A is a block diagram of an embodiment of the signal processing circuit in FIG. 3.

FIG. 5B is a block diagram of another embodiment of the signal processing circuit in FIG. 3.

FIG. 5C is a block diagram of a further embodiment of the signal processing circuit in FIG. 3.

FIG. 6 shows a block diagram of a transmitter in a RF transceiver that may be used in the signals processing circuits of FIGS. 5A-5C.

FIG. 7A is a block diagram of one embodiment of a processing apparatus and a communication module.

FIG. 7B is a block diagram of another embodiment of a processing apparatus and a communication module.

FIG. 8 is a block diagram of one embodiment of a device having a plurality of sockets that accept Memory Stick™ data storage media and a plurality of Memory Stick™ data storage media and/or communication modules.

The use of the same reference symbols in different drawings indicates similar or identical items.

### DETAILED DESCRIPTION OF THE INVENTION

A method and a device that are compatible with a socket that accepts removable data storage device, such as the Memory Stick™ made by Sony Corporation, and has the capability to create and control a communication link between two electronic devices are provided. Although the Memory Stick™ is mentioned herein, the invention may be implemented with any removable data storage device and a port or socket that receives or accepts the removable data storage device.

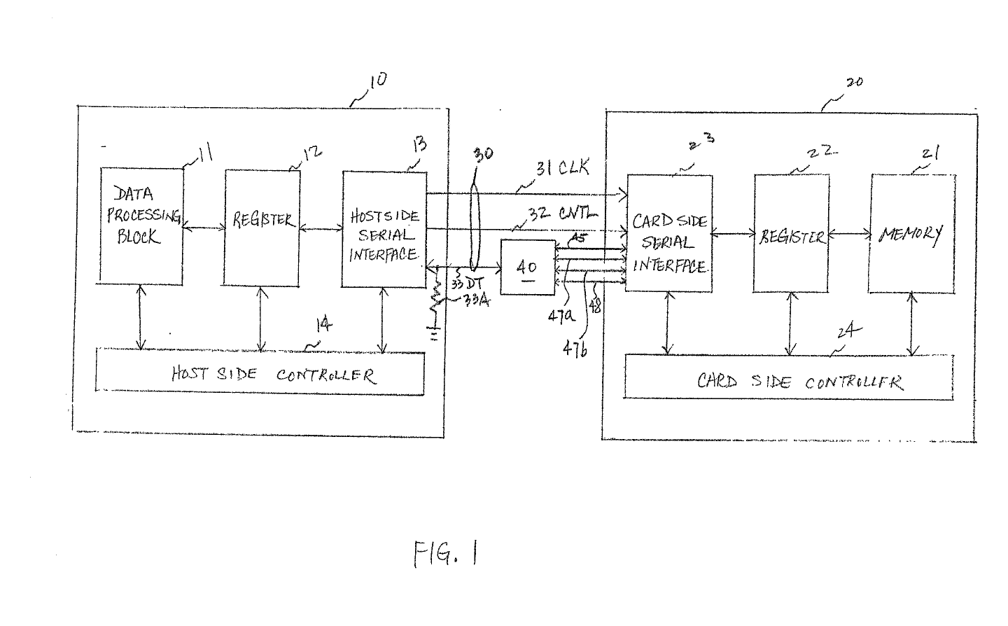

FIG. 1 depicts one embodiment of a data processing apparatus 10 (e.g., an apparatus for interfacing with Memory Stick™ data storage media) and a memory module 20, such as a Memory Stick™ data storage media. Data processing apparatus 10 includes a data processing block or circuit 11, a register 12, a host side serial interface circuit 13 and a host side controller 14. Data processing circuit 11 processes data stored in memory 21 in memory module 20 and performs data processing functions that generate data to be written to memory 21 in memory module 20. For example, data processing circuit 11 may process data for a computer apparatus, an apparatus for recording/reproducing a digital audio signal or an audio visual apparatus, which uses memory module 20.

Register 12 is a buffer between data processing circuit 11 and host side serial interface circuit 13. Data processing apparatus 10 temporarily stores data in register 12 and then supplies data to host side serial interface circuit 13 when data processing apparatus 10 supplies data from data processing circuit 11 to host side serial interface circuit 13. Similarly, register 12 temporarily stores data and supplies data to data processing circuit 11 from host side serial interface circuit 13.

Host side serial interface circuit 13 converts data stored in register 12 and one or more commands from host side controller 14 into serial signals to send to memory module 20. Host side serial interface circuit 13 also converts data and one or more commands from memory module 20 into parallel signals to supply to data processing circuit 11 and host side controller 14. Host side serial interface circuit 13 also supplies one or more synchronizing signals (CLK) for various data and commands via clock line 31 to memory module 20 and acquires a status signal (STATUS) which indicates a state of the operation of memory module 20 as part of a data signal (DT) via data line 33 from memory module 20.

Host side controller 14 controls data processing operations performed by data processing circuit 11 and data transmitting operations performed by host side serial interface circuit 13. Host side controller 14 supplies a control command (CNTL) to memory module 20 through register 12 via control line 32. Host side controller 14 supplies control signals to memory module 20 so that card side controller 24 may perform various operations based on the commands received from host side controller 114.

Memory module 20 comprises a memory 21, a register 22, a card side serial interface circuit 23 and a card side controller 24. For example, memory 21 may include a flash memory which stores data supplied from data processing circuit 11. Flash memory (sometimes called “flash RAM”) is a type of nonvolatile memory that can be erased and reprogrammed in units of memory. Other types of nonvolatile memory such as, but not limited to, battery-backed SRAM, PROM, EEPROM, may be used.

Register 22 is a buffer between memory 21 and card side serial interface circuit 23. When data from data processing apparatus 10 is written to memory 21, data is temporarily stored in register 22. Similarly, when data processing apparatus 10 reads data from memory 21, data is temporarily stored in register 22. In one embodiment, register 22 is a circuit performing a page buffer function.

Card side controller 24 controls card side serial interface circuit 23. Card side serial interface circuit 23 converts parallel signals from memory 21 and commands from card side controller 24 into serial signals to send to data processing apparatus 10. Card side serial interface circuit 23 also converts serial data and commands from data processing apparatus 10 into parallel signals to send to memory 21 and card side controller 24. Card side serial interface circuit 23 communicates with host side serial interface circuit 13 via a line 30. Specifically, card side serial interface circuit 23 receives a synchronizing signal (CLK), control signal (CNTL) and data (DT) from data processing apparatus 10 via lines 31, 32 and 33, respectively, and sends the status signal (STATUS) and data (DT) to data processing apparatus 10 via data line 33.

Card side controller 24 controls the operation of storing, reading and erasing data in memory 21 in accordance with a command from data processing apparatus 10. Card side controller 24 controls the data transmitting operation of card side serial interface circuit 23.

Data transmission between data processing apparatus 10 and memory module 20 is performed through a line or bus 30 arranged between host side serial interface circuit 13 and card side serial interface circuit 23. Line 30 comprises a clock line 31 for carrying a CLK signal from data processing apparatus 10 to memory module 20, a control line 32 for carrying a CNTL signal from data processing apparatus 10 to memory module 20 and a data line 33 for transferring data between data processing apparatus 10 and memory module 20. Data to be written to and read from memory 21, commands from memory module 20 and commands from data processing apparatus 10 are transmitted via data line 33. In addition, a status signal (STATUS) indicating the state of operation of memory module 20 is sent from memory module 20 to data processing apparatus 10 through data line 33.

In one embodiment, a status signal is transmitted when data and commands are not being transmitted. In one embodiment, the status signal includes a busy signal (BUSY) indicating that memory module 20 is performing a process. In one embodiment, when memory module 20 is performing a process, data processing apparatus 10 is inhibited from sending memory module 20 any commands or control signals. In one embodiment, the status signal includes an interrupt signal (INTERRUPT) that indicates an interruption from memory module 20 to data processing apparatus 10. For example, when an interruption command is requested from memory module 20 to data processing apparatus 10, the interrupt signal is supplied by the memory module 20. The status signal may include other signals.

A resistor 33A with a ground end is coupled to data line 33. In one embodiment, resistor 33A is a pull-down resister, i.e., when there is no communication between host side serial interface circuit 13 and card side serial interface circuit 23 through data line 33, the signal level of data line 33 is held at a predetermined level which is determined by the resistance value of resistor 33A. In an alternative embodiment, resistor 33A is a pull-up resistor, meaning that the signal level of data line 33 is at a high level when there is no communication via data line 33.

The control signal (CNTL) is transmitted from data processing apparatus 10 to memory module 20 through control line 32. A command handshake that identifies memory module 20 is provided via control line 32.

An output circuit 40 is interposed between card side serial interface 23 and host side serial interface 13. In one embodiment, output circuit 40 resides in memory module 20. However, output circuit 40 may reside in data processing module 10.

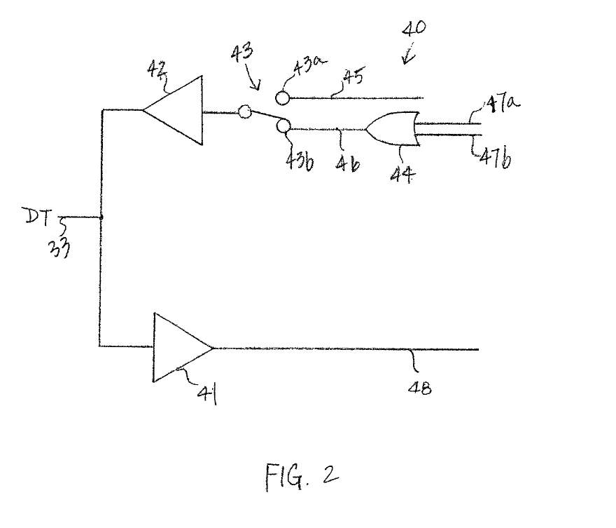

FIG. 2 shows one embodiment of output circuit 40 (FIG. 1) in detail. Output circuit 40 is disposed between card side serial interface circuit 23 and an I/O terminal of data line 33 (FIG. 1). Output circuit 40 includes an input buffer 41, an output buffer 42, a selection switch 43 and an OR circuit 44. Input buffer 41 is coupled to data line 33 to receive one or more serial signals from data processing apparatus 10 (FIG. 1). Input buffer 41 then supplies the serial signal(s) to card side serial interface circuit 23 (FIG. 1) via line 48.

Output buffer 42 produces an output to data line 33 from serial signal line 45, busy signal line 47a and interrupt signal line 47b, all from card side serial interface circuit 23, through a selection switch 43. OR circuit 44 ors busy signal line 47a and interrupt signal 47b line to produce a control signal on line 46 which is applied to terminal 43b of selection switch 43. Serial signal line 45 from card side serial interface circuit 23 (FIG. 1) is coupled to terminal 43a of selection switch 43. In one embodiment, when the control signal is high, selection switch 43 is switched to terminal 43a and when control signal is low, selection switch 43 is switched to terminal 43b. When selection switch 43 is switched to terminal 43a, the serial signal on line 45 obtained from card side serial interface circuit 23 (FIG. 1) is supplied to output buffer 42. When selection switch 43 is switched to terminal 43b, the status signals, such as busy signal on line 47a and interrupt signal on line 47b, transmitted from card side controller 24 (FIG. 1) are supplied to output buffer 42.

Memory module 20 may be, for example, a Memory Stick™ data storage media which has the following specifications listed in TABLE I.

TABLE I

| | |
|---|---|
| Memory Capacity | 4 MB |
| Dimensions | Approximately 0.85 × 1.97 × 0.11 inches |
| | (L × W × D) |
| Weight | Approximately 0.14 oz. |
| Memory Type | Flash Memory |
| Connector | 10-pin |
| Interface | Serial |
| Transfer Rate | Maximum 20 MHz |
| Access Speed | Writing Speed: Maximum 1.5 MB/second |
| | Reading Speed: Maximum 2.45 MB/second |
| Voltage | 2.7 V-3.6 V |
| Power Consumption | Average: Approximately 45 mA/Standby: |
| | maximum 130 mA |

It is noted that the Memory Stick™ data storage media may be of a different capacity, for example, 8 MB, 16 MB or 32 MB. The Memory Stick™ data storage media may also have other specifications depending on the application.

An example of the specification of a socket that interfaces with Memory Stick™ data storage media is listed in TABLE II below:

TABLE II

| | |
|---|---|
| Host Interface | PC card ATA/True IDE standard |
| Supported OS | Windows 95, Windows CE, Mac ® OS (system |
| | 7.5) |
| Dimensions | Adapter: approximately 3.35 × 2.13 s 0.2 in. |
| | (L × W × D) |
| | MSA-4A Memory Stick ™: 0.85 × 1.97 × 0.11 |
| | in. (L × W × D) |
| Weight | Approximately 1.1 oz. for adapter, 0.14 oz. for |
| | 4 MByte Memory Stick ™ |
| Power Consumption | Maximum 75 Ma |
| Operating voltage | 3.3 V/5.0 V |
| PC Card Type | PC card type II |

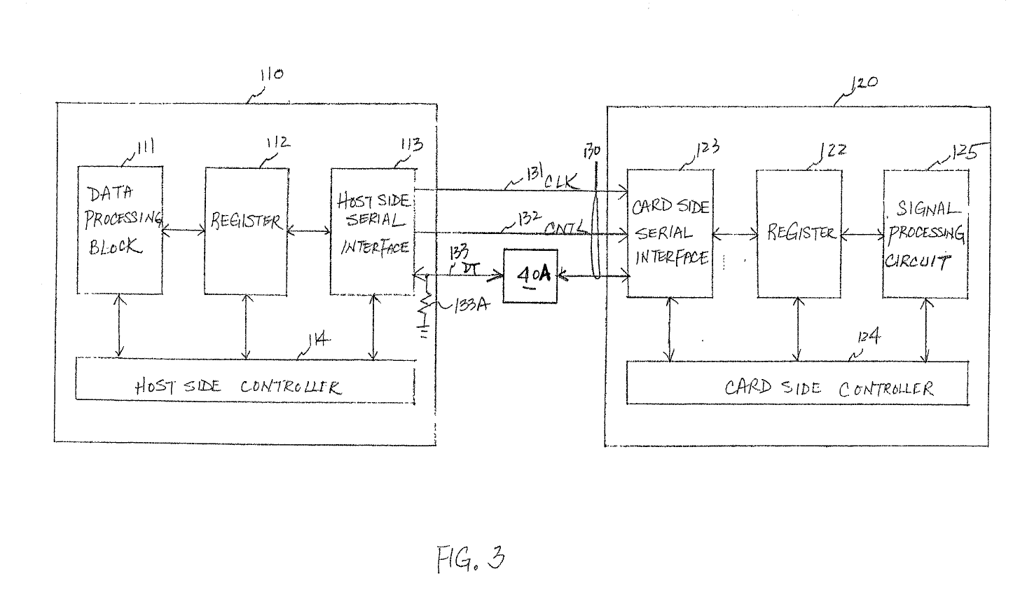

The communication module 120 (in FIG. 3 described below) in accordance with the present invention adds communication link capability to a socket based on the architecture of Memory Stick™ data storage media described above. Therefore, in one embodiment, the communication module 120 has the same physical dimensions and electrical properties of Memory Stick™ data storage media and is compatible with a socket that accepts Memory Stick™ data storage media, described above.

FIG. 3 depicts one embodiment of a data processing apparatus 110 (e.g., a socket which accepts Memory Stick™ data storage media) and a communication module 120 in accordance with the present invention. Data processing apparatus 110 is similar to data processing apparatus 10 depicted in FIG. 1. More specifically, data processing apparatus 110 includes a data processing circuit 111, a register 112, a host side serial interface circuit 113 and a host side controller 114. The data processing circuit 111 processes data received from signal processing circuit 125 in communication module 120 and performs data processes that generate data to be sent to signal processing circuit 125 in communication module 120. For example, data processing circuit 111 may serve as a data processing circuit for a computer apparatus, an apparatus for recording/reproducing a digital audio signal or an audio visual apparatus, which includes a socket that accepts Memory Stick™ data storage media.

Register 112 is a buffer between data processing circuit 111 and host side serial interface circuit 113. Data processing apparatus 110 temporarily stores data on register 112 and then supplies data to host side serial interface circuit 113 when data processing apparatus 110 supplies data from data processing circuit 111 to host side serial interface circuit 113. Similarly, data processing apparatus 110 temporarily stores data in register 112, and then supplies data to data processing circuit 111 when data processing apparatus 110 supplies data from host side serial interface circuit 113 to data processing circuit 111.

Host side serial interface circuit 113 converts data stored in register 112 and one or more commands from host side controller 114 into serial signals to send to card side serial interface 123, which then converts the serial signal to a signal recognizable by signal processing circuit 125. Host side serial interface circuit 113 also converts data and one or more commands from signal processing circuit 125 on communication module 120 into parallel signals to supply to data processing circuit 111 and host side controller 114. Host side serial interface circuit 113 also supplies one or more synchronizing signals (CLK) of various data and commands to communication module 120 via clock line 131 and acquires a status signal (STATUS) which indicates a state of operation from communication module 120 via data line 133.

Host side controller 114 controls data processing operations performed by data processing circuit 111 and the data transmitting operations performed by host side serial interface circuit 113. Host side controller 114 supplies a control command (CNTL) to communication module 120 through register 112 via control line 132.

The communication module 120 in FIG. 3 may be wired or wireless. In one embodiment, communication module 120 comprises a register 122, a card side serial interface 123, a card side controller 124 and a signal processing circuit 125. Register 122, card side serial interface 123 and card side controller 124 are similar to register 22, card side serial interface circuit 23 and card side controller 24, respectively, described above.

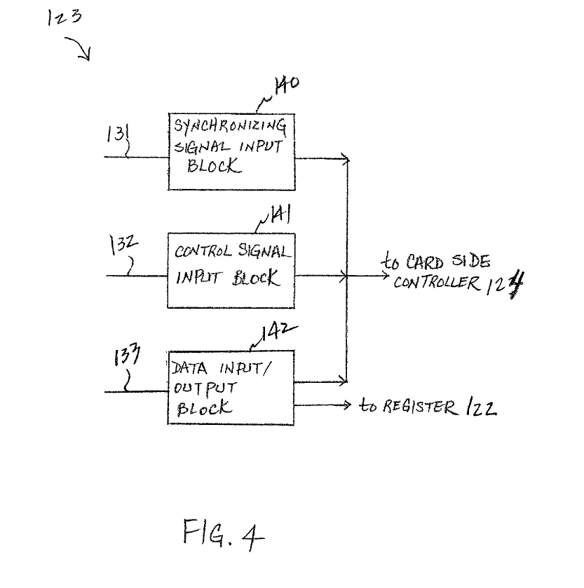

FIG. 4 shows one embodiment of card side serial interface 123 in FIG. 3 in detail.

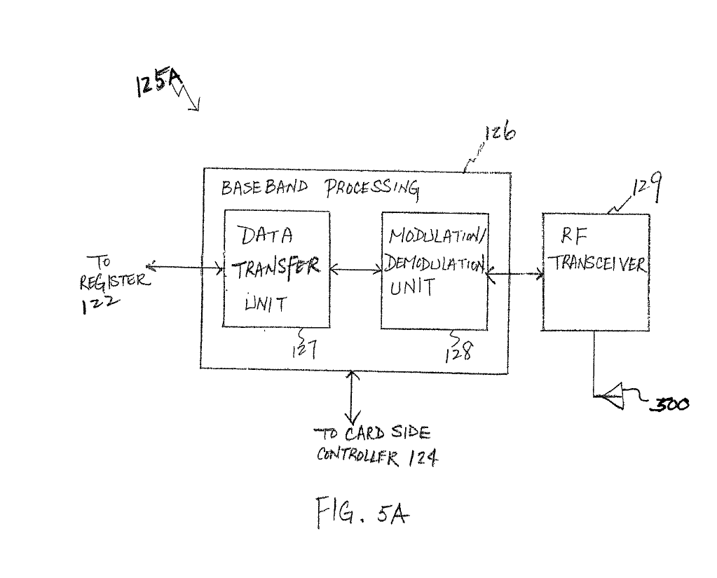

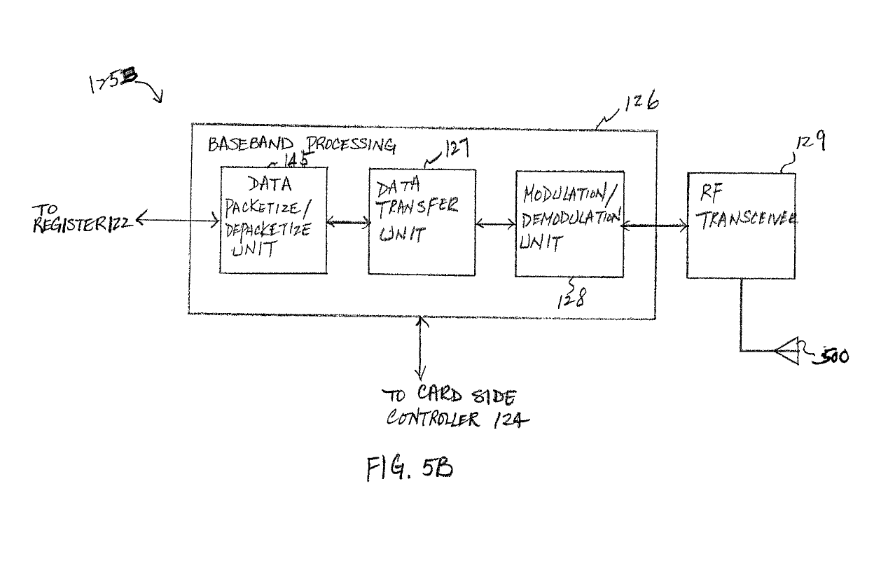

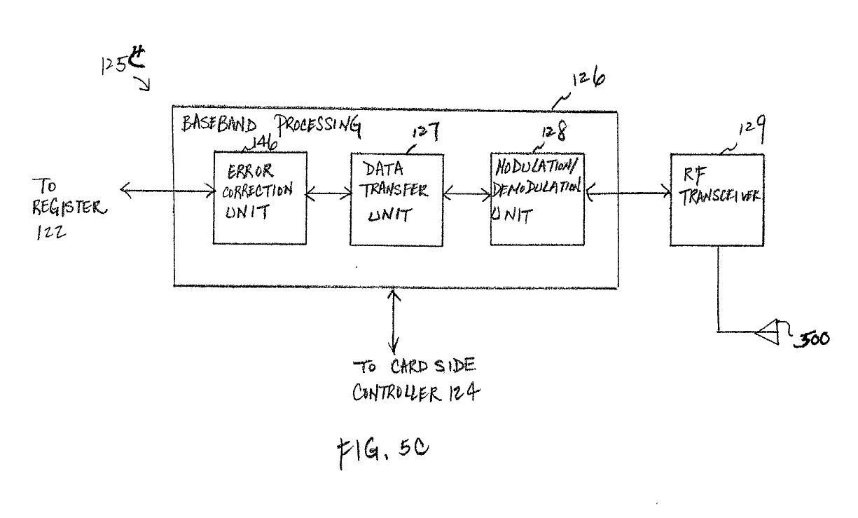

Card side serial interface 123 includes a synchronizing signal input circuit 140 for acquiring a synchronizing signal from data processing apparatus 110 (FIG. 3) via clock line 131, a control signal input circuit 141 for acquiring a control signal from data processing apparatus 110 via control line 132, and a data input/output circuit 142 for communicating data via data line 133. Card side controller 124 controls each of circuits 140, 141 and 142. Data input/output circuit 142 is coupled to register 122. Signal processing circuit 125 (FIG. 3) processes signals received from external devices (not shown) and processes signals to be sent to external devices. FIG. 5A shows a block diagram of one embodiment signal processing circuit 125 in FIG. 3.

To process a signal received by an antenna 500 (FIG. 5A) through an antenna coupler or connector (not shown) into a RF transceiver 129, RF transceiver 129 first subjects the received signal to reception processing. The reception processing converts the received signal to a signal of a predetermined transmission channel and supplies the processed received signal to a modulating and demodulating unit 128 in a baseband processing circuit 126. RF transceiver 129, data transfer unit 127 and modulation/demodulation unit 128 may be constructed according to techniques well known to those skilled in communication art and accordingly is not described herein.

Modulating and demodulating unit 128 (FIG. 5A) demodulates the received signal to convert the signal to a baseband signal and supplies the demodulated baseband signal to a data transfer unit 127. The data transfer unit 127 extracts data, e.g., an audio signal and control data, from the received signal and supplies the extracted audio signal and control data to register 122 (FIG. 3).

In one embodiment, referring to FIG. 5B, the baseband processing circuit 126 includes an optional data packetize/depacketize unit 145 for packetizing/depacketizing data prior to communicating data to register 122. Data packetizing/depacketizing unit 145 may be implemented by techniques well known to those skilled in the art.

In one embodiment, referring to FIG. 5C, the baseband processing circuit 126 includes an error correction unit 146 for correcting data error prior to communicating data to register 122. Error correction unit 146 may be implemented by techniques well known to those skilled in the art. Wireless local area networks (LANs) typically experience higher error rates than wired LANS, resulting in retransmission of frames. In addition, the collision avoidance mechanism is not as efficient as collision detection used in Ethernet, especially with a large number of users. Hence, packetization/depacketization and error correction result in more efficient transmission.

In one embodiment, the data transmission rate for communication is adjusted because the wireless link generally provides a much slower data transmission rate than a directly connected flash part. Data transmission rates are slower because of packetizing/depacketizing and error correction overhead. Repeated packets also slow down data transmission rates.

In one embodiment, an apparatus 110 (FIG. 3), such as a microphone, is capable of receiving or being coupled to the communication module 120. The apparatus 110 sends a digital signal (or analog signals converted to digital signals) to the data transfer unit 127 (FIGS. 5A, 5B, or 5C) within the signal processing circuit 125 (FIG. 3). The data transfer unit 127 subjects the signal to baseband processing to obtain a transmission signal, then sends the transmission signal to modulation and demodulation unit 128. Modulation and demodulation unit 128 carries out modulation processing for transmission. The modulation and demodulation unit 128 then sends the modulated signal to RF transceiver 129. RF transceiver 129 converts the modulated signal into a transmission signal of a predetermined transmission channel, and sends the transmission signal through the antenna coupler to antenna 500. The antenna 500 transmits the transmission signal wirelessly.

FIGS. 5A through 5C show various embodiments of a signal processing circuit 125, 125A, 125B for a wireless communication system. A wireless system eliminates many hardware requirements and adds mobility to the user. Generally, wireless communication is accomplished through the use of InfraRed (IR) or radio waves. The IEEE 802.11 and 802.11 b specifications provide standards for both the InfraRed frequencies and the radio wave frequencies.

In one embodiment, the wireless communication module, such as communication module 120 in FIG. 3, incorporates a low-power radio frequency (RF) module into the mechanical and electrical footprint of a Memory Stick™ data storage media. Low power RF has the advantage of being more cost effective and area efficient, in addition to low power consumption. In one embodiment, the RF power output of the module 120 is made high enough to work at a range of 150 feet.

In one embodiment, the RF module 120 uses frequencies in an unlicensed spectrum, such as the 2.4 GHz ISM band (Industrial, Scientific, and Medicine frequency band). The 2.4 GHz ISM band is selected for wireless transmission of information because the ISM band offers a multitude of applications in the 2.4-2.5 GHz range. There are no limitations to modulation type and bandwidth, and the use of channels is free of charge. Further, the ISM band is based on a broadband-FM-modulation. Thus, in addition to the transmission of colored moving pictures, two independent audio channels can also be used for data transmission depending on the requirements of the application. Currently, legal regulations permit a transmit power of 10 mW EIRP (Effective Isotropic Radiated Power) at maximum. The obtainable maximum range of 180 meters can be increased by the use of directional antennas at a receiving side.

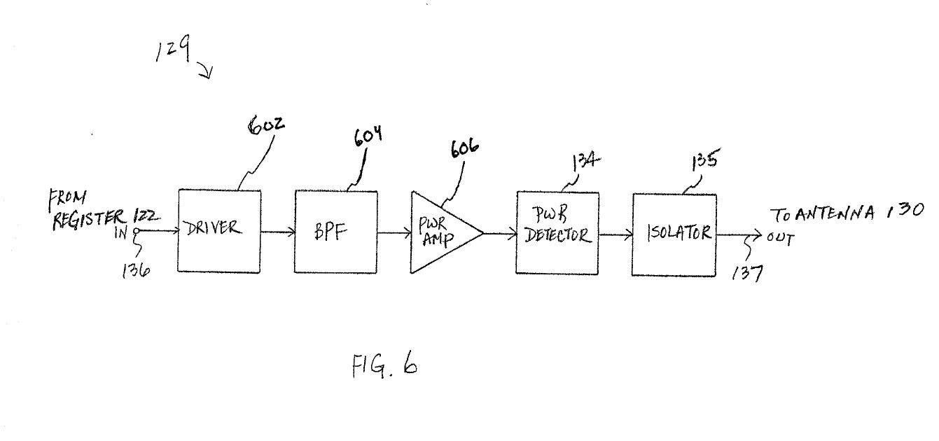

FIG. 6 shows a block diagram of a transmitter in a RF transceiver 129 that may be used in the signals processing circuits 125, 125A, 125B of FIGS. 5A-5C. An input signal, such as an audio or video signal, which is either analog or digital in its original form, modulated onto an RF carrier is supplied to a power amplifier 606 from an input terminal 136 by way of an amplifier driver 602 and a band pass filter 604. Power amplifier 606 amplifies the signal supplied from band pass filter 604 to suitable power levels and the amplified signal is coupled to an output terminal 137 by way of a power detector 134 and an isolator 135. Power detector 134 senses if the output power is too high. If the output power is too high, the transmitter in the transceiver 129 is shut down, for example, by interrupting the power supply output (not shown). Once supplied to output terminal 137, the amplified signal is coupled to an antenna such as antenna 500 in FIG. 5A, with a transceiver switch or a duplexer (not shown), thereby permitting the antenna to be used for both transmission and reception. The duplexer additionally is coupled to a signal receiving circuit (not shown) for receiving and processing a signal received by the antenna from a remote location.

Referring back to FIG. 3, register 122 is a buffer between signal processing circuit 125 and card side serial interface circuit 123. When data from data processing apparatus 110 is sent to signal processing circuit 125 in communication module 120, data is temporarily stored in register 122. Similarly, when data processing apparatus 110 receives data from signal processing circuit 125 in communication module 120, data is temporarily stored in register 122. In other words, register 122 acts as a buffer during transmission and receipt of signals.

Card side serial interface circuit 123 in FIG. 3 is controlled by card side controller 124. Card side serial interface circuit 123 converts parallel signals from signal processing circuit 125 and commands from card side controller 124 into serial signals to send to data processing apparatus 110. Card side serial interface circuit 123 also converts serial data and commands from data processing apparatus 110 into parallel signals to send to signal processing circuit 125 and card side controller 124. Card side serial interface 123 receives a synchronizing signal (CLK), control signal (CNTL) and data (DT) from data processing apparatus 110 and supplies the status signal (STATUS) and data (DT) to data processing apparatus 110.

The control signal (CNTL) in FIG. 3 is transmitted from data processing apparatus 110 to communication module 120 through control line 132. In one embodiment, a command handshake that identifies communication module 120 is also provided via control line 132. For example, when communication module 120 is inserted into the socket (i.e., data processing apparatus 110) and receives power from the socket, communication module 120 may send a message to data processing apparatus 110 that notifies data processing apparatus 110 of the communication module 120's presence. When data processing apparatus 110 receives the message, data processing apparatus 110 sends an acknowledgment signal back to communication module 120 that notifies communication module 120 that data processing apparatus 110 is aware of communication module 120's presence.

In the alternative, data processing apparatus 110 may poll periodically to determine whether a module is present and what type of module is present. In this embodiment, data processing apparatus 110 sends a periodic message via control line 132 to determine the presence of a module and the type of module present. If a module is present, it replies with a message along with its type information via, e.g., data line 133.

Card side controller 124 controls in FIG. 3 the operation of receiving and transmitting signals to and from signal processing circuit 125 in accordance with a command from data processing apparatus 110. Card side controller 124 controls the data transmitting operation of card side serial interface circuit 123.

Data transmission between data processing apparatus 110 and communication module 120 is performed through a transmission line or bus 130 arranged between host side serial interface circuit 113 and card side serial interface circuit 123. Transmission line 130 comprises a clock line 131 for transmitting a CLK signal, a control line 132 for transmitting a CNTL signal and a data line 133 for transmitting data. Data to be sent to and received from signal processing circuit 125, commands from communication module 120 and commands from data processing apparatus 110 are transmitted via data line 133. In addition, a status signal (STATUS) indicating the state of operation of communication module 120 is sent from communication module 120 to data processing apparatus 110 through data line 133.

In one embodiment, a status signal is transmitted when data and commands are not being transmitted. In one embodiment, the status signal includes a busy signal (BUSY) indicating that communication module 120 is performing a process. In one embodiment, when communication module 120 is performing a process, data processing apparatus 110 is inhibited from sending any signals to communication module 120. In one embodiment, the status signal includes an interrupt signal (INTERRUPT) that indicates an interruption from communication module 120 to data processing apparatus 110. It is noted that the status signal may include other types of signals.

The timing of receiving one or more signals is now described. In one embodiment, data processing apparatus 110 (FIG. 3) sends the control signal (CNTL) to communication module 120 via control line 132. After communication module 120 receives the control signal, communication module 120 prepares to receive a command from data processing apparatus 110. Host side controller 14 in data processing apparatus 110 sends a receiving command to communication module 120 via data line 133 in addition to a synchronizing signal to communication module 120 via clock line 131. Data processing system 110 may then stop sending signals to communication module 120.

After communication module 120 receives the receiving command, communication module 120 may send a busy signal to data processing apparatus 110 via data line 133. Data processing apparatus 110 determines whether communication module 120 is busy. Communication module 120 reads the data that was received from the signal processing circuit 125 and temporarily stored in register 122. Communication module 120 then stops sending or modifies the busy signal on line 133 to indicate that the communication module 120 has completed the preparation for supplying the data to transfer to data processing apparatus 110.

Data processing apparatus 110 sends the control signal and the synchronizing signal to the communication module 120. Communication module 120 then synchronizes the data with the synchronizing signal supplied via data line 133 to transmit synchronized data to data processing apparatus 110. After communication module 120 has completed the transmission of data, data processing apparatus 110 interrupts the transmission of the synchronizing signal and the control signal.

If the internal state of communication module 120 changes due to, e.g., the receiving process, communication module 120 sends an interrupt signal to indicate an interruption to data processing apparatus 110 via data line 133. Data processing apparatus 110 receives the interrupt signal and determines the cause of the interruption by sending a control signal and a corresponding command.

The protocol between communication module 120 and external devices is preferably not a unique protocol, so communication module 120 can link to any device that uses the same protocol and not be limited to other devices having a communication module. If a unique protocol is used, devices on either side of the communication link may have compatible communication modules using the same protocol.

In general, the communication module 120 may use any wireless LAN protocol.

In one embodiment, the communication module 120 uses IEEE 802.11 specification, which has been widely adopted by manufacturers of PCMCIA network cards. An advantage of IEEE 802.11 specification is the possibility to communicate with many devices in the same time because IEEE 802.11 allows peer to peer communication. However, other wireless LAN protocols such as Open Air Interface, WaveLAN, WinData, RadioLAN, HiperLAN and Bluetooth may be used in addition to or instead of IEEE 802.11.

In the embodiment where multiple devices are communicating with each other, device identification numbers (IDs) are assigned to each device. Device IDs may be set by hardware or software. But in general, any addressing scheme may be used.

A resistor 133A in FIG. 3 with a grounded end is coupled to data line 133. In one embodiment, resistor 133A is a pull-down resistor, i.e., when there is no signal communication between host side serial interface circuit 113 and card side serial interface circuit 123 via data line 133, the signal level of data line 133 is held at a predetermined level which is determined by the resistance value of resistor 133A. In an alternative embodiment, resistor 133A is a pull-up resistor, meaning that the signal level of data line 133 is at a high level when there is no signal communication via data line 133.

The output circuit 40A in FIG. 3 between card side serial interface 123 and host side serial interface 113 may be the same as output circuit 40 described above and shown in FIG. 2.

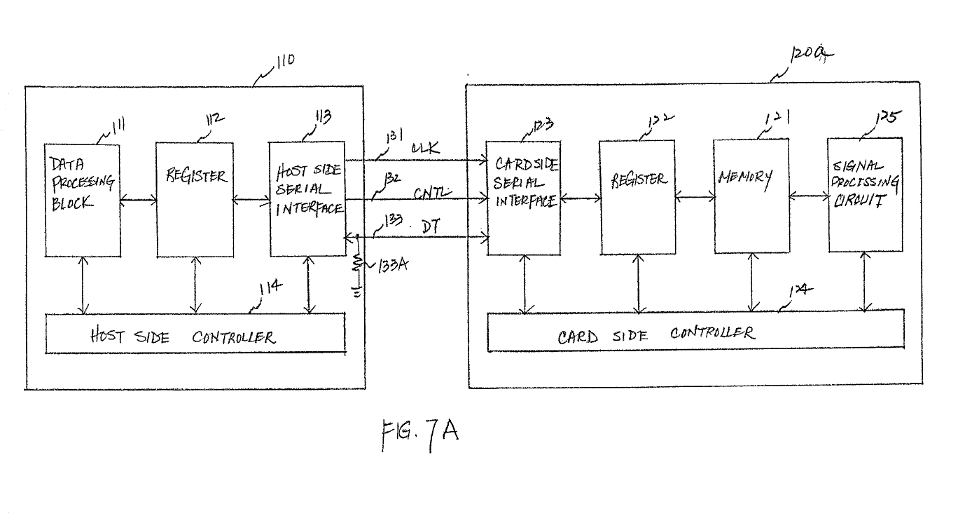

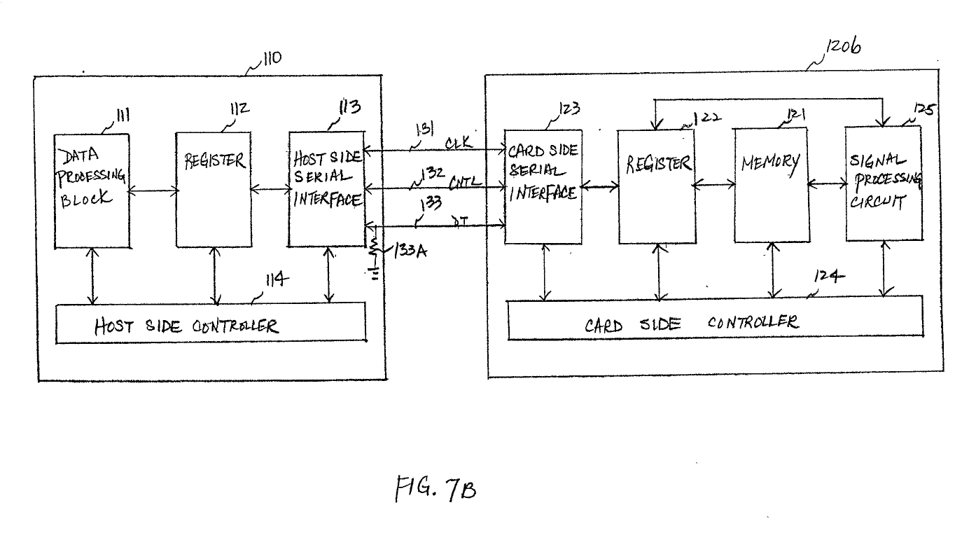

FIG. 7A is another embodiment in accordance with the present invention where communication capability is integrated into a memory module (or memory capability is integrated into a communication module). This combination saves physical space required for the added communication components and saves manufacturing cost.

Data processing apparatus 110 in FIG. 7A is similar to that described above with reference to FIGS. 1 and 3. Communication module 120a includes a memory 121, a register 122, a card side serial interface 123, a card side controller 124 and a signal processing circuit 125. Communication module 120a is similar to communication module 120 described above with reference to FIG. 3 with the addition of a memory 121 coupled between register 122 and signal processing circuit 125. In this embodiment, processed received signals can be stored in memory 121.

In one embodiment, referring to FIG. 7B, memory 121 and signal processing circuit 125 are both coupled to register 122 such that received signals can be stored in memory 121 and processed in signal processing circuit 125 simultaneously (in parallel). In one embodiment, the same data can be written to the memory and sent to the signal processing circuit simultaneously.

Memory 121 includes, for example, a flash memory, which stores data sent from data processing circuit 111 or data from an external device. Card side controller 124 controls storing, reading and erasing data in memory 121 in accordance with a command from data processing apparatus 110.

In one embodiment, communication module 120 (FIG. 3) or 120a (FIG. 7A) or 120b (FIG. 7B) is implemented in conventional flash-cards that are used throughout the industry. For example, for an identified application, the communication module 120, 120a or 120b may be combined with a general-purpose flash to create a storage/communication device.

In one embodiment, the communication module 120, 120a, 120b is configured for hot-swap. Hot-swap is a method of allowing insertion and extraction of components without adversely affecting system operation. In other words, hot-swap allows the insertion and extraction of components without requiring the system to be turned off and will not affect the system operation adversely. In one embodiment, hot-swap specification such as PCMCIA (Personal Computer Memory module International Association) 2.1 or 3.0 standard for type I and type II PCMCIA PC cards is used.

Typically, hot-swap allows the digital system to remain powered during circuit board insertions or removals by controlling circuit board voltages during insertion and removal. A typical hot-swap circuit controls board voltage by using various methods such as the use of discrete logic, proximity sensors, and other types of electrical techniques. In one embodiment, when the communication module 120, 120a, 120b is inserted, the interface portion of the card is powered on, but the RF circuitry is not enabled until the interfacing software has enabled the module 120, 120a, 120b. Once the communication module 120, 120a, 120b is powered up, a scan of compatible devices is performed prior to creating a dynamically defined network between the communication module 120, 120a, 120b and the data processing apparatus 110.

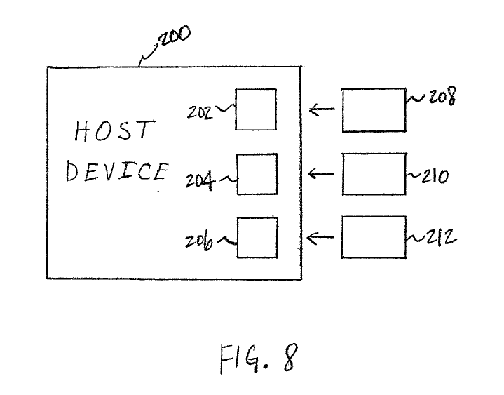

Referring to FIG. 8, in one embodiment, multiple sockets 202, 204, 206 configured to communicate with Memory Stick™ data storage media are incorporated into a host device 200. By having multiple sockets, hot-swapping may be eliminated. For example, for a local host device with only one socket for accepting Memory Stick™ data storage media, the user needs to perform the following acts when transferring information from a Memory Stick™ data storage media to a device at a remote location: insert the Memory Stick™ data storage media into a local host device; copy the information from the Memory Stick™ data storage media into a memory of the local host device; remove the Memory Stick™ data storage media from the local host device; insert the communication module (such as module 120 in FIG. 3) in the local host device; and send the copy of the content of the Memory Stick™ data storage media from the memory in the local host device to the remote device.

Similarly, the user needs to perform the following acts to store data from a remote device onto a Memory Stick™ data storage media: insert the communication module into the local host device; store the received data in a memory in the local host device; remove the communication module from the local host device; insert the Memory Stick™ data storage media into the local host device; and transfer the received data from the memory in the local host device to the Memory Stick™ data storage media.

With multiple sockets capable of interfacing with Memory Stick™ data storage media available on the same device, e.g., the local host device 200 in FIG. 8, Memory Stick™ data storage media 208 may be inserted into one socket 202 while communication module 210 may be inserted into another socket 204 and Memory Stick™ data storage media 212 may be inserted into another socket 206. The content in the Memory Stick™ data storage media 208 may be transferred via the communication module 210 to a remote device without the need to insert/remove the Memory Stick™ data storage media 208 and the communication module 210. Another advantage of multiple sockets is that data storage and data communication may be carried out at the same time.

In one embodiment, hot-swap capability is provided for at least one socket so that the Memory Stick™ data storage media 208 may be changed when it is full without having to shut down the system.

The apparatus described above allows data transfer, control, or streaming multimedia from one host device to another or to a collection of devices. For example, from a portable music player that is within range of a home entertainment system, a user can select songs from a fixed music library at the portable music player and listen to them wirelessly using a home phone with a socket capable of interfacing with Memory Stick™ data storage media and a communication module.

As used herein, a ‘socket’ may comprise a port, a connector or any interface configured to transfer a signal. A Memory Stick™ data storage media, a memory module 20 (FIG. 1) or a communication module 120 (FIG. 3), 120a (FIG. 7A) 120b (FIG. 7B) may fit completely, partially or not at all within a ‘socket.’

Although the invention has been described with reference to particular embodiments, the description is only an example of the invention's application and should not be taken as a limitation. Various other adaptations and combinations of features of the embodiments disclosed are within the scope of the invention as defined by the following claims.

We claim:

1. A communication module, comprising:
an interface circuit configured to communicate data to a data processing apparatus, the interface circuit comprising:
a synchronizing signal input circuit configured to receive a synchronizing signal from the data processing apparatus;
a control signal input circuit configured to receive a control signal from the data processing apparatus; and
a data input/output circuit configured to communicate with the data processing apparatus;
a signal processing circuit coupled to the interface circuit and configured to process the data; and
a controller coupled to the interface circuit and the signal processing circuit, the controller being configured to control the interface circuit and the signal processing circuit.

2. The module of claim 1, further comprising a register coupled to the signal processing circuit, the register being configured to temporarily store the data.

3. The module of claim 1, further comprising a memory coupled to the signal processing circuit, the memory being configured to store the data.

4. The module of claim 3, wherein the memory comprises non-volatile memory.

5. The module of claim 3, wherein the memory comprises flash memory.

6. The module of claim 1, wherein the signal processing circuit comprises a radio frequency (RF) transceiver.

7. The module of claim 6, wherein said RF transceiver uses frequencies in an unlicensed spectrum.

8. The module of claim 6, wherein said RF transceiver uses an ISM (Industrial, Scientific, and Medicine) frequency band.

9. The module of claim 1, wherein the signal processing circuit comprises:
a transceiver configured to transmit and receive the data; and
a baseband processing unit configured to process the data.

10. The module of claim 9, wherein said baseband processing unit comprises a modulating/demodulating unit configured to convert said signal to a baseband signal.

11. The module of claim 9, wherein the baseband processing unit further comprises a packetize/depacketize unit.

12. The module of claim 9, wherein the data comprises a signal selected from the group consisting of a digital audio signal and a video signal.

13. The module of claim 1, wherein the interface circuit converts parallel signals into serial signals.

14. A communication module comprising:
an interface circuit configured to be coupled to a port of a first electronic device, the port being configured to receive data from a memory module; and
a receiver coupled to the interface circuit, the receiver being configured to wirelessly receive at least one signal from a second electronic device and send the signal to the interface circuit, wherein the interface circuit is configured to send data associated with at least one signal received by the receiver to the port of the first electronic device.

15. The communication module of claim 14, wherein the port is configured to receive data from a Memory Stick™ data storage media.

16. The communication module of claim 14, wherein the communication module is sized to fit substantially within a socket of an electronic device, the socket being configured to receive a Memory Stick™ data storage media.

17. The communication module of claim 14, wherein the communication module further comprises a memory coupled to the receiver and the interface circuit, the memory being configured to store data associated with at least one signal received by the receiver, the interface circuit being configured to send data from the memory to the port of the first electronic device.

18. The communication module of claim 14, wherein the communication module further comprises a Memory Stick™ data storage media coupled to the receiver and the interface circuit, the Memory Stick™ data storage media being configured to store data associated with at least one signal received by the receiver, the interface circuit being configured to send data from the Memory Stick™ data storage media to the port of the first electronic device.

19. A communication module comprising:
an interface circuit configured to be coupled to a port of a first electronic device, the port being configured to send data to a memory module; and
a transmitter coupled to the interface circuit, wherein the interface circuit is configured to send data from the port of the first electronic device to the transmitter, the transmitter being configured to wirelessly transmit at least one signal associated with the data from the port of the first electronic device to a second electronic device.

20. A data processing apparatus with a port configured to communicate with and be coupled to a removable memory module and a removable communication module.

21. The data processing apparatus of claim 20, wherein the module comprises:
an interface circuit configured to communicate data to the communication module, the interface circuit comprising:
a synchronizing signal input circuit configured to transmit a synchronizing signal to the communication module;
a control signal input circuit configured to transmit a control signal to the communication module; and
a data input/output circuit configured to communicate the data with the communication module;
a data processing circuit coupled to the interface circuit, the data processing circuit configured to process the data; and
a controller coupled to the interface circuit and the data processing circuit, the controller configured to control the interface circuit and the data processing circuit.

22. The data processing apparatus of claim 21, further comprising a register coupled to the interface circuit and the data processing circuit, the register configured to temporarily store data.

23. The data processing apparatus of claim 21, wherein the interface circuit comprises a clock line, a control line and a data line.

24. The data processing apparatus of claim 23, further comprising a resistor coupled to the data line at a first terminal and grounded at a second terminal.

25. The data processing apparatus of claim 23, further comprising an output circuit coupled to an interface circuit of the communication module and an input/output terminal of the data line.

26. The data processing apparatus of claim 21, further comprising a second interface circuit.

27. The data processing apparatus of claim 21, wherein the interface circuit is capable of hot-swapping.

28. A method of using a communication module, the method comprising:
coupling the communication module to a port of a first electronic device, the port being configured to send data to a memory module;
sending data from the port of the first electronic device to the communication module; and
wirelessly transmitting at least one signal associated with the data from the communication module to a second electronic device.

29. The method of claim 28, further comprising packetizing data for transmission to the second electronic device.

30. The method of claim 28, further comprising modulating the data to obtain a signal to be transmitted by the communication module.

31. The method of claim 28, further comprising storing the data in a register prior to sending the data from the port of the first electronic device to the communication module.

32. A method of using a communication module, the method comprising:
coupling the communication module to a port of a first electronic device, the port being configured to receive data from a memory module;
wirelessly receiving at least one signal from a second electronic device at the communication module; and
sending data associated with at least one signal received by the communication module to the port of the first electronic device.

33. The method of claim 32, further comprising generating a signal for synchronizing data transmission timing between the first electronic device and the communication module.

34. The method of claim 32, further comprising generating a signal for controlling data transmission between the first electronic device and the communication module and transmitting data in response to the control signal.

35. The method of claim 32, further comprising transmitting a handshake signal between the first electronic device and the communication module for identifying the communication module.

36. The method of claim 32, further comprising:
demodulating the received signal to obtain a baseband signal; and
extracting data from the signal.

37. The method of claim 32, further comprising depacketizing data from the signal received by the communication module.

38. The method of claim 32, further comprising performing an error correction operation on the data.

39. The method of claim 32, further comprising storing the data in a register.

40. The method of claim 32, further comprising transmitting a status signal indicating a state of operation of the communication module.

41. The method of claim 40, wherein the status signal comprises a busy signal indicating that the communication module is performing a process.

42. The method of claim 40, wherein the status signal comprises an interrupt signal indicating an interruption from the communication module to the first electronic device.

43. The method of claim 32, further comprising hot-swapping the communication module.

44. The method of claim 32, wherein the hot-swapping comprises:
powering an interface of the communication module when the module is coupled to the first electronic device; and
enabling a signal processing circuit using an interfacing software subsequent to the powering.

45. The method of claim 32, further comprising determining a model type of the communication module and establishing a communication link with the communication module if the communication module is a compatible device.

46. A communication module comprising:
an interface circuit configured to be coupled to a port of a first electronic device, the port being configured to send and receive data to and from a memory module; and
a transceiver coupled to the interface circuit, the transceiver being configured to wirelessly receive at least one signal from a second electronic device and send the signal to the interface circuit, wherein the interface circuit is configured to send data associated with at least one signal received by the receiver to the port of the first electronic device, the interface circuit being further configured to send data from the port of the first electronic device to the transceiver, the transceiver being configured to wirelessly transmit at least one signal associated with the data from the port of the first electronic device to a second electronic device.
